(19) United States
(12) Patent Application Publication
(10) Pub. No.: US 2026/0127070 A1
(43) Pub. Date: May 7, 2026

(54) Buffer Component for Interleaving Data and Metadata for Error Correction

(71) Applicant: Rambus Inc., San Jose, CA (US)

(72) Inventor: Thomas Vogelsang, Jericho, VT (US)

(21) Appl. No.: 19/358,090

(22) Filed: Oct. 14, 2025

Related U.S. Application Data
(60) Provisional application No. 63/715,432, filed on Nov. 1, 2024.

(51) Int. Cl. G06F 11/10

(52) U.S. Cl. CPC G06F 11/1004

(57) ABSTRACT

A memory buffer services commands from a host to access data in a memory using parity bits augmented with metadata for improved error correction and detection (EDC). The memory buffer performs EDC-protocol translation so EDC can be optimized for host-side and memory-side correction and detection. The memory buffer also services each host-side memory transaction with two or more memory-side transactions to efficiently read, write, and store metadata for each requested cache-line access.

### FIELD OF THE INVENTION

The subject matter presented herein relates to error correction for memory systems and modules.

### BACKGROUND

Personal computers, workstations, and servers include at least one processor, such as a central processing unit (CPU), and some form of memory system that includes dynamic, random-access memory (DRAM). The processor executes instructions and manipulates data stored in the DRAM.

DRAM stores binary bits by alternatively charging or discharging capacitors to represent the logical values one and zero. The capacitors are exceedingly small, and their stored charges can be upset by electrical interference or high-energy particles. The resultant changes to the stored instructions and data produce undesirable computational errors.

Some computer systems, such as high-end servers, employ various forms of error detection and correction to manage DRAM errors, or even more permanent memory failures. The general idea is to add storage for extra information that can be used to identify and correct for errors. By way of example, conventional servers that support error correction commonly include memory modules that read and write data in 512-bit (512 b) chunks called “cache lines. ” Cache lines are spread across four DRAM dies that each communicates 512 b/4=128 b per read or write transaction. Adding a fifth DRAM die allows the memory to communicate an additional 128 b of parity data per transaction, which increases the size of a cache line to 640 b per transaction. The 128 b parity bits are calculated for each 512 b write transaction and the resulting 640 b cache line is stored together at the same memory address. The data and parity data are read back together and the parity bits are used for error detection and correction (EDC) robust enough to correct for any single DRAM die failure as long as it is known which is the failing single die.

Parity data sufficient to correct an error may be insufficient to identify the source of the error. A defective resource, such as a bad connection or memory device, can thus go uncorrected or even unnoticed. Additional data—sometimes called “metadata”—can be stored with data and parity bits to identify sources of errors and thus avoid silent data corruption. Unfortunately, this improvement requires additional memory and can diminish memory speed performance.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 includes a simplified block diagram of a memory system 100 in which a memory buffer 105 services commands from a host 110 to access data in a memory 115 using parity bits augmented with metadata for improved error detection and correction (EDC).

FIG. 2 depicts a memory buffer 200 with a host-side DDR5 physical interface (phy) 205 and a pair of LPDDR5 DRAM physical interfaces phy 210.0 and phy 210.1.

FIG. 3A shows waveform diagrams 300 and 310 respectively illustrating read and write transactions directed by a host and managed by memory buffer 200 of FIG. 2.

FIG. 3B shows waveform diagram 320 and 330 respectively illustrating interleaved read and write transactions directed by a host and managed by memory buffer 200 of FIG. 2.

FIG. 4 is a flowchart 400 illustrating the roles of a host and memory buffer in managing successive read transactions to a pair of DRAM ranks 0 and 1.

FIG. 5 depicts a memory system 500 in which a host controller 505 has access to a memory module 510 with five DRAM components 515.

### DETAILED DESCRIPTION

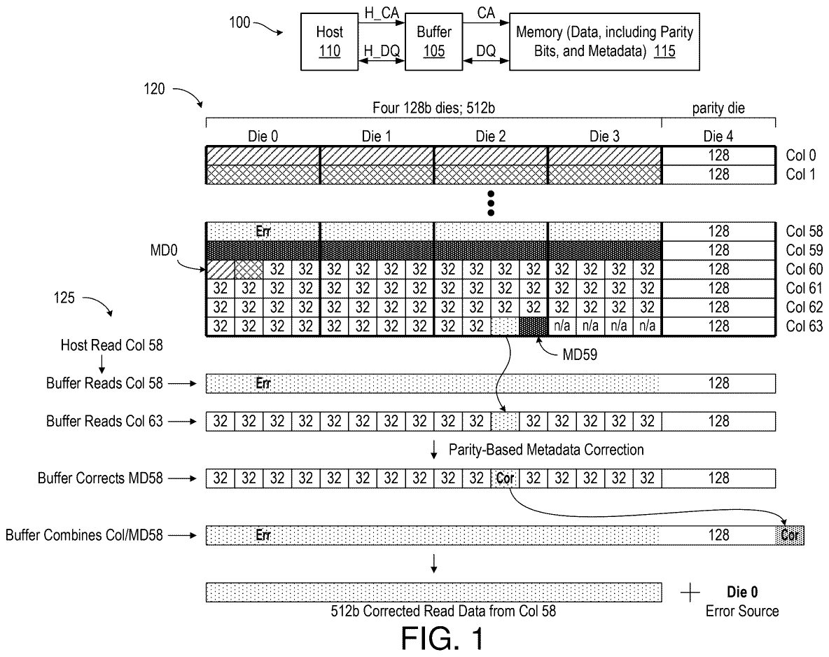

FIG. 1 includes a simplified block diagram of a memory system 100 in which a memory buffer 105 services commands from a host 110 to access data in a memory 115 using parity bits augmented with metadata for improved error detection and correction (EDC). The EDC improvements do not require the participation of host 105 and come without significant hardware overhead or reduced speed performance.

A diagram 120 shows how data, parity bits, and metadata for enhanced EDC are distributed among sixty-four columns Col[63:0] across five memory dies Die[4:0]. Each of the first sixty columns Col[59: 0] includes 512 b of data, 128 b on each of dies Die[3:0], 128 b of parity data. (The term “data” here refers to the information conveyed from host 110 for storage and related parity bits buffer 105 calculates from the host data.) Each of the last four columns Col[63:60] is divided into sixteen 32 b sub-columns, sixty of which stores metadata (data about data) for a corresponding one of columns Col[59:0]. The sub-columns are addressed from zero to sixty from left to right, top to bottom, so that the leftmost sub-column of Col[60] is metadata zero (MD0) and corresponds to the data of column Col0 and the rightmost sub-column of metadata in Col[63] is MD59 and corresponds to the data of column Col59. Columns Col[63:60] have four more 32 b sub-columns than are used by columns Col[59:0]; the extra sub-columns are labeled “n/a”and can be used for other purposes.

There appears at the bottom of FIG. 1 a flow diagram 125 illustrating a transaction initiated by host 110 to read the host data from column Col58. In this example, target column Col58 includes an error Err in one of the 128 bits stored in Die0; the remaining dies D[4:1] are error free in Col58. As detailed below, buffer 105 manages the requested read transaction by reading the data and parity bits from column Col58, reading the metadata and parity bits from column 63, and correcting the data of Col58, Dies[3:0] with the parity bits of Col58, Die4, and the 32 b of metadata in column Col63, MD59.

Buffer 105 responds to the host read command by issuing its own command to the commanded address in memory 115, column Col58 in this example, and calculates the address offset for the corresponding metadata. While memory 115 is servicing the command directed to Col58, buffer 105 issues a second command to column Col63 to read the metadata. This transaction reads the entire column, including the 128 parity bits, to allow buffer 105 to run EDC on the metadata, correcting the metadata if need be. Buffer 105 then uses the corrected metadata from MD59 and the parity bits of Col58 to perform EDC on the host data. In this example, the parity bits allow buffer 105 to correct the error in the read data and the extra 32 b of metadata allow buffer 105 to identify the errant die as Die0. Buffer 105 conveys the EDC-treated 512 b data to host 110 and logs the identity of the errant die.

Buffer 105 might include a register or employs a memory location accessible to memory-system firmware or the operating system to log errors and the identities of errant dies. An error log might include the type of error (single-bit, multi-bit), the die or dies where the error occurred, and a timestamp or counter for error frequency.

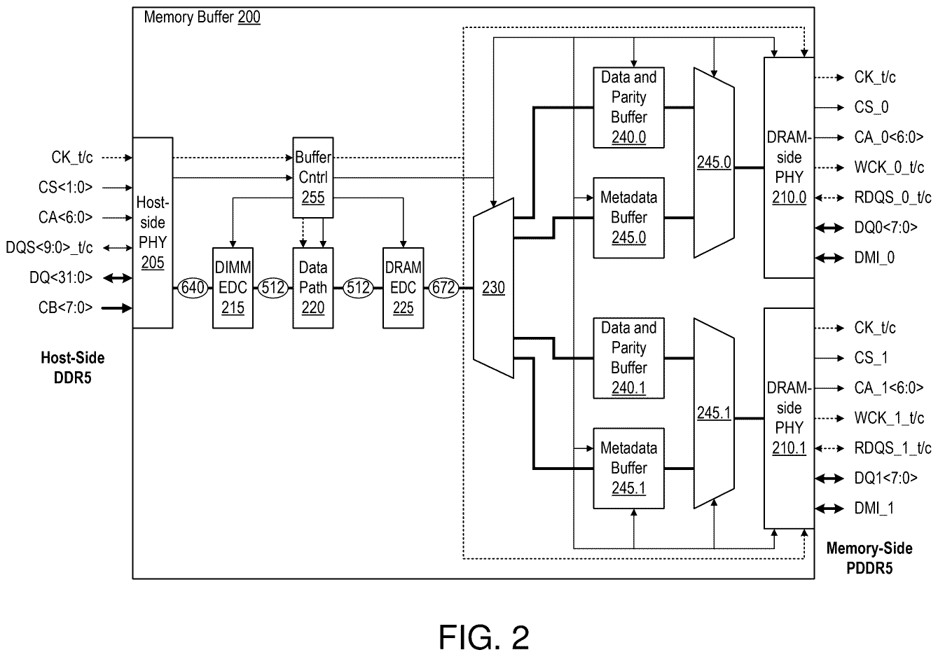

FIG. 2 depicts a memory buffer 200 with a host-side DDR5 physical interface (phy) 205 and a pair of LPDDR5 DRAM physical interfaces phy 210.0 and phy 210.1. DDR5 (Double Data Rate 5) is the fifth generation of the Double Data Rate Synchronous Dynamic Random-Access Memory (SDRAM) technology. LPDDR5 (Low Power DDR5) is a low-power variant of DDR5 designed for mobile devices, such as smartphones, tablets, and notebooks, where power efficiency and compact size are especially important. DRAM-side interfaces 210.0 and 210.1 connect to respective dies, each of which communicates data of width eight over a respective channel DQ #<7:0>in sixteen-bit bursts so that each transaction communicates 8×16=128 b. Buffer 200 likewise supports communication with four other pairs of dies so that each transaction communicates 4×128 b=512 b in the manner illustrated in FIG. 1. The four additional pairs of dies are omitted for ease of illustration.

DDR and LPDDR interfaces are well known so a detailed discussion is omitted. Briefly, on the host side:
CK_t/c is a clock signal used to synchronize the operation of the host with buffer 200 and the memory.
CS<1: 0> are a pair of chip-select signals that allow the host to select one or the other of the two ranks of memory devices or banks for read/write operations (A “rank,” or “memory rank,” refers to a set of DRAM dies that operate in unison and are accessed together).
CA<6:0>, for “command/address,” delivers command signals (like row address strobe RAS, column address strobe CAS, or write enable WE) and address information directing access to specific location in memory.
DQS<9:0>_t/c, Data Strobe, communicates a complementary pair of timing signals with each byte of data in both read and write directions.
DQ<31:0> is a 32-bit-wide channel for communicating host data to and from memory in bursts of sixteen bits. Each memory transaction thus communicates 32×16 b=512 b (64 bytes) of data.
CB<7:0> is an eight-bit-wide channel for communicating Check Bits used for error correction in bursts of sixteen bits. Each memory transaction thus communicates 8×16 b=126 b (16 bytes) for EDC.

The DRAM-side signals are similar to the host-side signals, but there are differences.
CK_t/c is the like-named clock signal from the host.
CS_0 and CS_1 are chip-select signals derived from host chip-select signal CS<1:0> to allow the host to select one or the other of the two ranks of memory devices or banks for read/write operations.
CA0<6:0> and CA1<6:0> are the command/address signals that control respective DRAM ranks.
WCK_0_t/c and WCK_1_t/c are write clock signals that are similar to CK_t/c but are specific to write operations.
RDQS_0_t/c and RDQS_1_t/c are rank-specific read data strobe signals used in source-synchronous DDR memory interfaces to capture read data.
DQ0<7:0> and DQ1<7:0> are data channels of width eight that communicate in sixteen-bit bursts for a transaction granularity of 8×16 b=128 b. Each host transaction involves five simultaneous device transactions for a total of 5×128 b=640 b.
DMI_0 and DMI_1 are Data Mask Input signals and can be used in write operations to mask or disable writing to certain DQ pins during a write cycle. DMI pins are used for partial writes where only a subset of the memory available to a given transaction is to be overwritten.

In the write direction, host data DQ and check bits CB from phy 205 are conveyed to a host-side EDC block 215, which uses the check bits to detect and correct errors in the data bits to address link errors and passes the resulting 512 b of data to a data path 220. Data path 220 transfers data between the host and memory sides and might include registers to adjust the timing of the data so that data and CA on the host side and memory side are aligned according to their respective specifications. EDC block 215 can use an EDC technology known as “Memory Chipkill™” that can tolerate and correct a failure of an entire memory chip's worth of bits.

Data path 220 passes the 512 b write data to a memory-side EDC block 225 that uses the write data to calculate 128 b of parity data and 32 b of metadata to be used in the manner noted in connection with FIG. 1. The resultant 672 bits are conveyed to a multiplexer 230 that steers the data and parity bits to one of two data and parity buffers 240.0 and 240.1, the one indicated by chip-select signal CS<1:0>, and the metadata to a corresponding one of two metadata buffers 245.0 and 245.1. Assuming a write transaction directed to DRAM phy 210.0 (CS<1:0>=01), the write data and parity bits are stored in buffer 240.0 and the metadata in buffer 245.0. The data/parity bits and metadata bits are then communicated to a connected DRAM die (not shown) via successive write transactions over DRAM-side phy 210.0. Each host write command is thus translated into a successive pair of DRAM-side write transactions. (Metadata write transactions additionally call for a preliminary read transaction to read parity bits that are updated with changed metadata. This process is described below.). The flow of data, parity, and metadata bits is reversed for read transactions. Briefly, buffer responds to each host read command with a pair of successive read transactions that deliver the data/parity bits and the metadata, respectively, from the same DRAM rank. A buffer controller 255 manages the flow of data through memory buffer 200 responsive to chip-select CS<1:0> and command/address CA<6:0j> signals in the manner detailed below.

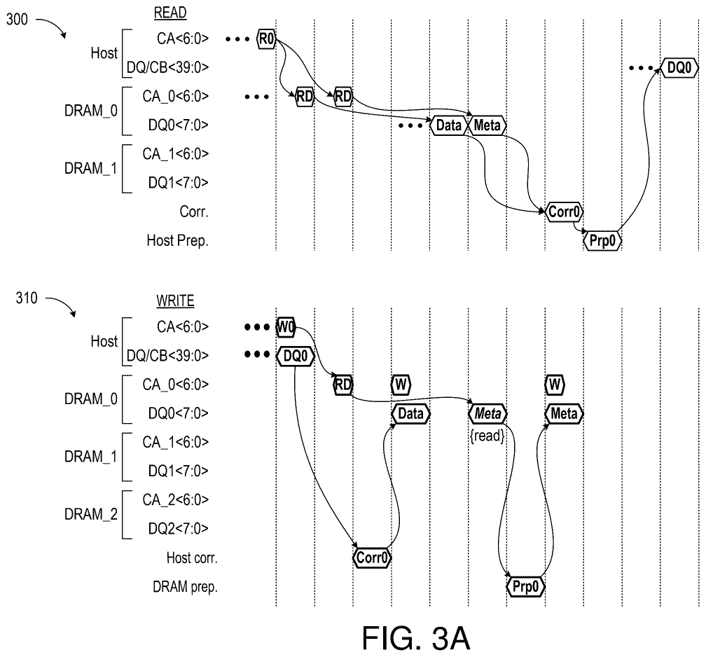

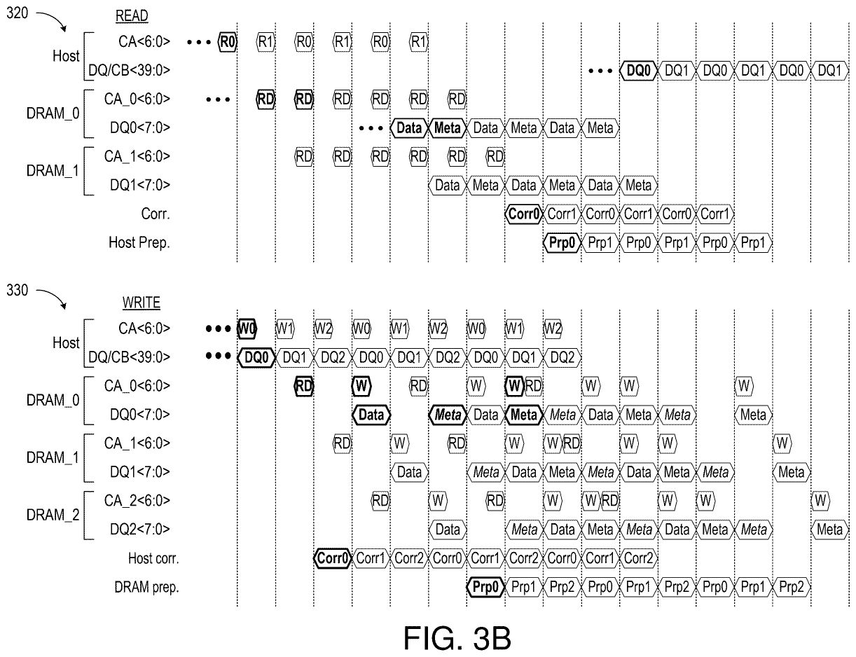

FIG. 3A shows a waveform diagram 300 illustrating a read transaction directed by a host to a memory device DRAM_0 and managed by memory buffer 200 of FIG. 2. This illustration focuses on a response from an individual DRAM die; a complete transaction, including parity bits, would combine five dies to communicate data of width 5×8 b=40 b. A burst length of 16 b means each die communicates 128 b per transaction, and five dies communicate 640 b (80 B) per transaction.

The host initiates a read transaction by issuing an activate command R0 directed to rank 0. Buffer 200 responds with a sequence of two activate commands RD. The first activate command RD causes memory die DRAM_0 to provide data Data over channel DQ0<7:0>; the second activate command RD causes the same memory die DRAM_0 to provide metadata Meta in the next memory cycle. (Buffer 200, using DRAM EDC 225, performs error correction and detection Corr0 using the data, parity, and metadata bits. The error-corrected data is then encoded by EDC block 215 (Prp0) so the requested read data can be communicated to the host on channel DQ/CB<39: 0>as Data in an error-resistant format. Interleaved read transactions from multiple DRAM dies are discussed below in connection with FIG. 3B. Where EDC block 225 uses Memory Chipkill™, EDC block 215 calculates a “syndrome” of check bits for each cache line and communicates the data and cache line together to host-side phy 205 for transmission to the host.

FIG. 3A also includes a waveform diagram 310 illustrating a write transaction initiated by a host and performed with support from a buffer like buffer 200 of FIG. 2 but with a third DRAM-side interface DRAM_2. A host-side write command W0 induces the buffer to manage two DRAM-side write transactions, one for data/parity bits and another for metadata. Parity bits are a function of all the metadata in the target column, not just the newly calculated 32 b, so the DRAM-side write transactions are preceded by a read transaction that reads the target metadata column. The parity bits are recalculated using the new and existing metadata and the new cache line is written back to the DRAM column address from whence it came.

Beginning in diagram 310 at the upper left, the host initiates a write transaction by issuing a write command and contemporaneous write data DQ0. Host-side EDC block 215 performs EDC on host data DQ0 using the accompanying check bits (Corr0). Buffer-control block 265 calculates the address of the metadata associated with the commands write address and directs DRAM-side phy 210.0 to read from that address and store the resultant cacheline of metadata and parity bits (Meta) in metadata buffer 245.0. While awaiting the cacheline Meta, DRAM-side phy 210.0 issues a write command WR and the corrected data Data to DRAM_0.

Metadata calculated for data Data is then inserted into the metadata Meta read from the DRAM and new parity bits are calculated for the updated information. The buffer then issues a second write command WR with accompanying updated metadata and parity bits (Meta) to write the updated metadata to DRAM_0. All the metadata will be the same as read but for the 32 b for the newly written data, and the parity bits for the metadata will be updated to reflect the new metadata. Interleaved write transactions to multiple DRAM dies are discussed below in connection with FIG. 3B.

FIG. 3B includes a waveform diagram 320 illustrating a sequence of interleaved read transactions directed by a host to memory devices DRAM_0 and DRAM_1 and managed by memory buffer 200 of FIG. 2. The host initiates the read transactions by issuing activate commands R0 and R1 directed to ranks 0 and 1, respectively. FIG. 3B also includes a waveform diagram 330 illustrating an interleaved sequence of write transactions. Of interest, the duration of each command burst is half that of each data or metadata burst. This difference between durations allows write and read commands to share the same time slot as one used to convey metadata, which makes interleaving more efficient. The pipelining is extended to three ranks, represented by memory dies DRAM_[2:0], to allow for the additional read transaction used in write operations to extract the metadata and parity bits used to update the metadata cacheline. Should only two ranks be available, the achievable write bandwidth would be ⅔ of the read bandwidth.

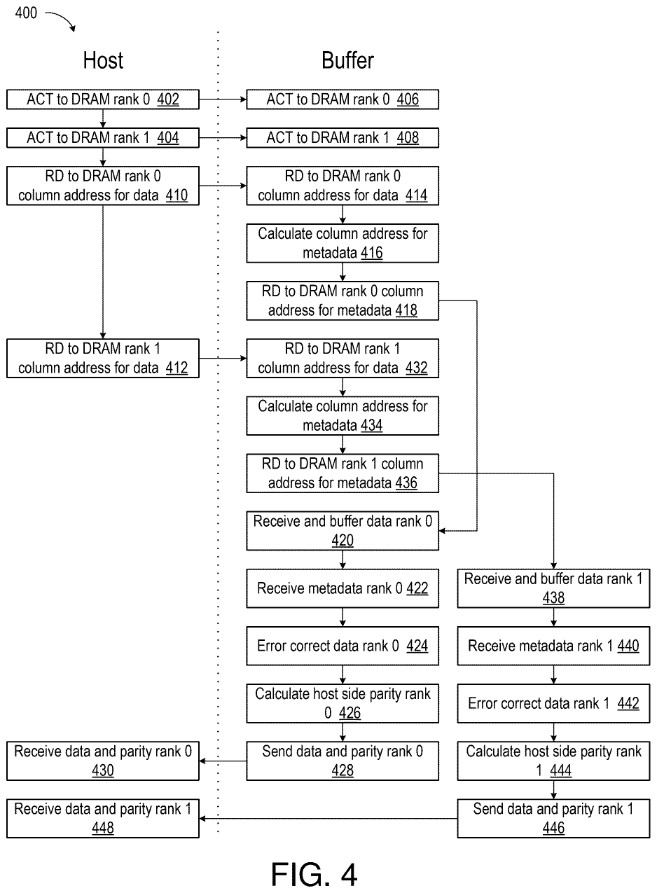

FIG. 4 is a flowchart 400 illustrating the roles of a host and memory buffer in managing successive read transactions to a pair of DRAM ranks 0 and 1. The process begins with the host issuing successive activate commands 402 and 404 to ranks 0 and 1, respectively. The buffer responds by issuing activate commands 406 and 408 to the target devices. DRAM devices are organized into banks with rows and columns. Each activate command (or ACT) specifies the address of a row within a bank. The command is meant to “activate” the row by copying the contents of the row into a set of sense amplifiers (not shown). Once a row is activated, the DRAM is ready for either a read or a write operation. In this example, however, the ACT commands from the host do not act directly on the memory. Rather, the buffer intercepts the host commands and responds to each with multiple accesses to the target DRAM.

The astute reader may have noticed that activate commands 402 and 404 are directed to a “rank” rather than a DRAM die. A “rank” refers to a set of DRAM dies that operate in unison and are accessed together. The host specifies a rank for each access. Each DRAM die in a rank has a chip-select input that can be asserted to prepare the dies, and thus the rank, for activation. A set of e.g. five dies can be selected and activated together, in which case a column of data from the host perspective combines five columns from respective DRAM dies. Having multiple ranks can increase memory bandwidth by allowing the host to switch between ranks, effectively accessing different memory locations in parallel or quickly one after another. The host in this illustration uses rank interleaving, where data is spread across ranks 0 and 1 to improve throughput, which hides some of the latency associated with metadata operations.

The host follows up the activate commands with read (RD) commands 410 and 412 to the active columns of DRAM ranks 0 and 1. The buffer interleaves responses to the read commands. Considering rank 0 first, the buffer issues a DRAM-side read command to rank 0 targeting the column address of the active row (414) and calculates the column address for the metadata associated with the active column (416). The buffer then issues a second DRAM-side read command to the column address of the metadata (418). The buffer receives, responsive to the read commands of 414 and 418, data and parity bits from the column addressed by the host (420) and metadata and parity bits from the calculated column address (422). The buffer performs EDC on the data using the parity bits associated with the data and the 32 b of metadata that is part of the metadata column (424). EDC can be performed on the metadata using the accompanying parity bits before step 424. Host-side parity bits are then calculated for the error-corrected read data (426) and the buffer sends the resultant encoded data to the host (428). The host then receives the EDC-encoded data (430) responsive to the original commands of steps 402 and 410.

Memory buffer manages the read command of step 412 in the same manner as the command of step 410. The buffer issues a DRAM-side read command to rank 1 targeting the column address of the active row (432) and calculates the column address for the metadata associated with the column (434). The buffer then issues a second DRAM-side read command to the column address of the metadata (436). The buffer receives, responsive to the read commands of 432 and 436, data and parity bits from the column addressed by the host (438) and metadata and parity bits from the calculated column address (440). The buffer performs EDC on the data using the parity bits associated with the data and the 32 b metadata block that is part of the metadata column (442). EDC can be performed on the metadata using the accompanying parity bits. Host-side parity bits are then calculated for the error-corrected read data (444) and the buffer sends the resultant encoded data to the host (446). The host then receives the EDC-encoded data (448) responsive to the original commands of steps 402 and 410.

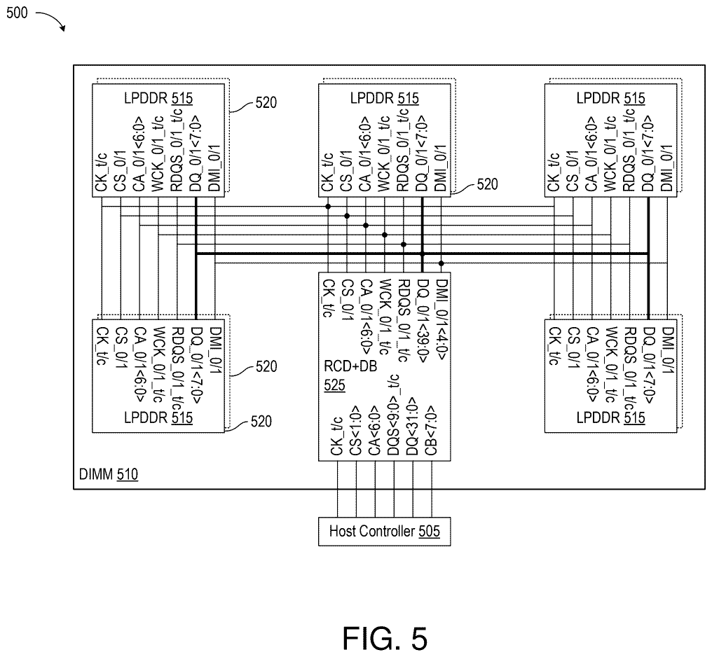

FIG. 5 depicts a memory system 500 in which a host controller 505 has access to a memory module 510 with five DRAM components 515. Each memory component 515 includes a package with two DRAM dies 520. The uppermost dies are accessible as a rank Rank0 and the lowermost dies, illustrated using dashed lines, are accessible as a rank Rank1. In other embodiments the ranks can be e.g. different memory dies on either side of module 510 or separate collections of banks on the same dies. A memory buffer 525 manages memory transactions and EDC in the manner described above.

Metadata transactions take place between buffer 525 and DRAM components 515. Managing a memory transaction on a module with a buffer rather than via the host offers several efficiency advantages. The distances signals travel are minimized, which translates into lower latency for memory access, less signal degradation, and more power-efficient communication.

Memory buffer 525 is labeled “RCD+DB,” an abbreviation for “Registered Clock Driver and Data Buffer. ” The term “buffer” refers to devices facilitate signal transfer between systems with different operational speeds or characteristics. A “registered clock driver (RCD)” is a circuit used in memory modules, particularly in Registered Dual In-line Memory Modules (RDIMMs) and Load-Reduced DIMMs (LRDIMMs), to buffer, register, or re-drive clock, command, and address signals sent from a host, such as a memory controller, to the DRAM chips on a memory module. This example integrates the above-described EDC blocks and related control circuitry with traditional buffer circuitry with a DDR5 host interface and five LPDDR5 DRAM device interfaces. These different memory interfaces conform to different communication standards that define ways in which memory can be accessed, how commands are issued, and how data is transferred between integrated-circuit memory components.

While the invention has been described with reference to specific embodiments thereof, it will be evident that various modifications and changes may be made thereto without departing from the broader spirit and scope of the invention. For example, features or aspects of any of the embodiments may be applied, at least where practicable, in combination with any other of the embodiments or in place of counterpart features or aspects thereof. Moreover, some components are shown directly connected to one another while others are shown connected via intermediate components. In each instance the method of interconnection, or “coupling,” establishes some desired electrical communication between two or more circuit nodes, or terminals. Such coupling may often be accomplished using a number of circuit configurations, as will be understood by those of skill in the art. Therefore, the spirit and scope of the appended claims should not be limited to the foregoing description. Only those claims specifically reciting “means for” or “step for” should be construed in the manner required under the sixth paragraph of 35 U.S.C. § 112.

What is claimed is:

1. A method for managing read and write transactions with first and second ranks of memory devices, the method comprising:
receiving a read command, from a host, to access the first rank at a first memory address and, responsive to the read command:
issuing a first command to the first rank at the first memory address;
receiving first read data from the first memory address;
calculating a second memory address of the second rank from the first memory address;
issuing a second command to the second rank at the second memory address;
receiving second read data from the second memory address, the second read data including a subset of metadata;
detecting an error in the first read data;
correcting the error in the first read data with the metadata to produce corrected data; and
conveying the corrected data to the host.

2. The method of claim 1, wherein the second read data includes parity data, the method further comprising detecting an error in the metadata using the parity data.

3. The method of claim 1, wherein the first and second commands responsive to a sequence of read commands, including the read command, are interleaved.

4. The method of claim 1, wherein the read command follows a first interface standard and the first command follows a second interface standard different from the first interface standard.

5. The method of claim 1, further comprising:
receiving a write command to store write data at the first memory address and, responsive to the write command:
calculating the second memory address of the second rank from the first memory address and second metadata from the write data;
issuing a read command to the second memory address to receive third read data; and
replacing a subset of the third read data with the second metadata to produce modified data; and
writing the modified data back to the second memory address.

6. The method of claim 5, further comprising writing, responsive to the write command, the write data to the first memory address.

7. The method of claim 1, wherein the first read data includes parity bits, and wherein detecting the error in the first read data uses the parity bits.

8. The method of claim 7, wherein the second read data includes second parity bits, and wherein the detecting the error omits the second parity bits.

9. The method of claim 7, wherein the second read data includes second parity bits, the method further comprising detecting a second error in the second read data using the second parity bits.

10. The method of claim 1, further comprising calculating check bits and adding the check bits to the corrected data before conveying the corrected data to the host.

11. A buffer for providing a host with access to a memory, the buffer comprising:
a host interface to receive host commands, including a host read command;
a first memory interface to issue, responsive to the host read command, a first command to a first rank of the memory at a first memory address, the first memory interface to receive first read data from the first memory address responsive to the first command;
a control block to calculate a second memory address as a function of the first memory address;
a second memory interface to issue, responsive to the host read command, a second command to a second rank of the memory at the second memory address, the second memory interface to receive second read data from the second memory address responsive to the second command, the second read data including a subset of metadata; and
an error-detection-and-correction (EDC) block to correct an error in the first read data using the metadata to produce corrected data;
the host interface to transmit the corrected data to the host.

12. The buffer of claim 11, wherein the second read data includes parity data and the EDC block detects a second error in the metadata using the parity data.

13. The buffer of claim 11, the host interface to receive a write command to store write data at the first memory address, the control block to calculate the second memory address from the first memory address, and the EDC block to calculate second metadata from the write data.

14. The buffer of claim 13, the first memory interface to communicate the write data to the first rank and the second metadata to the second memory address.

15. The buffer of claim 14, the second memory interface further to read from the second memory address to convey parity bits to the control block, the EDC block to calculate updated parity bits using the second metadata, the second memory interface to second metadata, the first memory interface to write the second metadata and the updated parity bits to the second memory address responsive to the write command.

16. The buffer of claim 11, further comprising a second EDC block to add check bits to the corrected data, the host interface to transmit the corrected data with the check bits.

17. The buffer of claim 16, wherein the metadata is of metadata bits fewer than the check bits.

18. The buffer of claim 11, wherein the corrected data has fewer bits than the sum of the first read data and the metadata.

19. The buffer of claim 18, wherein the corrected data has fewer bits than the first read data.

20. A module comprising:
a first rank of memory devices;
a second rank of memory devices; and
a memory buffer for managing read and write transactions with the first and second ranks of memory devices, the memory buffer comprising:
a host interface to receive host commands, including a host read command;
a first memory interface to issue, responsive to the host read command, a first command to a first rank of the memory at a first memory address, the first memory interface to receive first read data from the first memory address responsive to the first command;
a control block to calculate a second memory address as a function of the first memory address;
a second memory interface to issue, responsive to the host read command, a second command to a second rank of the memory at the second memory address, the second memory interface to receive second read data from the second memory address responsive to the second command, the second read data including a subset of metadata; and
an error-detection-and-correction (EDC) block to correct an error in the first read data using the metadata to produce corrected data.
